(19) United States
(12) Patent Application Publication
(10) Pub. No.: US 2008/0117138 A1
(43) Pub. Date: May 22, 2008

(54) Plasma display device and driving method thereof

(76) Inventors: Sookwan Jang, Yongin-si (KR); Heungsik Tae, Yongin-si (KR)

Correspondence Address: ROBERT E. BUSHNELL, 1522 K STREET NW, SUITE 300, WASHINGTON, DC, 20005-1202, US

(21) Appl. No.: 11/882,868

(22) Filed: Aug. 6, 2007

(30) Foreign Application Priority Data
Nov. 22, 2006 (KR) 10-2006-0116050

(51) Int. Cl. G09G 3/28

(52) U.S. Cl. 345/63

(57) ABSTRACT

In a plasma display device and a method of driving the plasma display device, one frame is divided into a plurality of sub-fields and each sub-field includes a reset period, an address period, and a sustain period. The method includes: supplying a first rising ramp pulse to at least one scan electrode during a rising period of a reset period and simultaneously supplying a second rising ramp pulse to at least one sustain electrode, and supplying a first falling ramp pulse to the at least one scan electrode during a falling period of the reset period and simultaneously supplying a second falling ramp pulse to the at least one sustain electrode.

### CLAIM OF PRIORITY

This application makes reference to, incorporates the same herein, and claims all benefits accruing under 35 U.S.C. §119 from an application for PLASMA DISPLAY DEVICE AND DRIVING METHOD THEREOF earlier filed in the Korean Intellectual Property Office on the Nov. 22, 2006 and there duly assigned Serial No. 10-2006-0116050.

### BACKGROUND OF THE INVENTION

1. Field of the Invention

The present invention relates to a plasma display device and a driving method thereof. More particularly, the present invention relates to a plasma display device and a driving method thereof which reduces dark image retention as well as stably driving an address.

2. Description of the Related Art

A plasma display device displays a character or an image using a plasma generated by a gas discharge. The plasma display device includes a Plasma Display Panel (PDP) for configuring a picture and a plurality of driving circuits for driving the PDP.

The display panel of such a plasma display device is driven with one frame divided into a plurality of subfields each having a weight value. During an address period of each sub-field, a light emitting cell and a non-light emitting cell are selected, and during a sustain period, a sustain discharge is implemented in correspondence with the light emitting cell to display images. A gray level is expressed by the combination of weight values of the sub-field with which the cell emits light.

FIG. 1 is a graph of the relationship between the firing voltage and voltage difference among the electrodes of a prior art panel according to temperature.

In FIG. 1, A-Y represents a voltage difference between the address electrode A and the scan electrode Y, and X-Y represents a voltage difference between the sustain electrode X and the scan electrode Y. Dots forming a hexagonal area represent the firing voltage. Therefore, if a cell voltage which is voltage difference among electrodes exists in the inner hexagonal area, a discharge does not start, and if a cell voltage exists in the outer hexagonal area, a discharge is generated.

As illustrated in FIG. 1, when the temperature of the panel from the prior art plasma display device varies, the firing voltage changes. That is, when the temperature of the panel increases from a low to a high temperature, the firing voltage of a surface discharge \textcircled{a} between a scan electrode and a sustain electrode decreases, and when the temperature of the panel decreases from a high to a low temperature, the firing voltage of surface discharge increases. However, the firing voltage of the opposed discharge between scan electrode and address electrode is constant, and the firing voltage of the opposed discharges \textcircled{b} between sustain electrode and address electrode is unchanged regardless of the panel temperature variation. Likewise, a reset discharge is varied according to the firing voltage which varies in accordance with the temperature of the panel. That is, once the temperature of the panel increases, a reset discharge is generated quickly and the amount of a reset light increases. Once the temperature of the panel decreases, a reset discharge is generated slowly and the amount of the reset light decreases. Accordingly, dark image retention (that is, the brightness of the background increases) occurs around the area wherein the temperature of the panel is increasing due to a large amount of the reset light, while the brightness of the background decreases around the area wherein the temperature of the panel is decreasing due to a small amount of the reset light. As the temperature of the panel varies, the strength of address discharge at both the high and low temperatures weakens, thereby causing an unstable driving.

### SUMMARY OF THE INVENTION

It is an object of the present invention to provide a plasma display device and a driving method thereof which reduces dark image retention as well as driving an address stably.

These and other objects of the present invention may be achieved by providing a method of driving a plasma display device, the method including: dividing one frame into a plurality of sub-fields, each sub-field including a reset period, an address period, and a sustain period; supplying a first rising ramp pulse to at least one scan electrode during a rising period of a reset period and simultaneously supplying a second rising ramp pulse to at least one sustain electrode; and supplying a first falling ramp pulse to the at least one scan electrode during a falling period of the reset period and simultaneously supplying a second falling ramp pulse to the at least one sustain electrode.

The first rising ramp pulse preferably rises gradually from a first voltage to a second voltage and the second rising ramp pulse preferably rises gradually from a third voltage to a fourth voltage.

The first falling ramp pulse preferably falls gradually from a fifth voltage to a sixth voltage and the second falling ramp pulse preferably falls gradually from a seventh voltage to a fourth voltage.

A voltage level of the fifth voltage is preferably lower than that of the first voltage.

The method further preferably includes supplying a scan pulse to the at least one scan electrode in sequence during an address period and preferably supplying an address pulse to at least one address electrode.

The method preferably further includes supplying a bias voltage having a voltage level equal to the fourth voltage level to the at least one sustain electrode during the address period.

The method preferably further includes alternately supplying the sustain pulse to the at least one scan electrode and at least one sustain electrode during the sustain period.

The seventh voltage is preferably higher than the fourth voltage and lower than a maximum voltage level of the sustain pulse.

A voltage difference between the fourth voltage and the seventh voltage is preferably equal to a voltage difference between the fifth voltage and the first voltage.

These and other objects of the present invention may also be achieved by providing a plasma display device in which one frame is divided into a plurality of sub-fields and each sub-field includes a reset period, an address period, and a sustain period, the device including: a Plasma Display Panel (PDP) including a plurality of scan and sustain electrodes, and including a plurality of address electrodes arranged to cross the scan and sustain electrodes; a scan driver to supply a first rising ramp pulse to at least one scan electrode during a rising period of the reset period, and to supply a first falling ramp pulse to the at least one scan electrode during a falling period of the reset period; a sustain driver to supply a second rising ramp pulse to the at least one sustain electrode during the rising period of the reset period, and to supply a second falling ramp pulse to the at least one sustain electrode during the falling period of the reset period.

The first rising ramp pulse preferably rises gradually from a first voltage to a second voltage and the second rising ramp pulse preferably rises gradually from a third voltage to a fourth voltage.

The first falling ramp pulse preferably falls gradually from a fifth voltage to a sixth voltage and the second falling ramp pulse preferably falls gradually from a seventh voltage to the fourth voltage.

A voltage level of the fifth voltage is preferably lower than that of the first voltage.

The scan pulse is preferably supplied to the at least one scan electrode in sequence during the address period and the address pulse is preferably supplied to the at least one address electrode.

A bias voltage having a voltage level equal to the fourth voltage level is preferably supplied to the at least one sustain electrode during the address period.

The sustain pulse is preferably alternatively supplied to the at least one scan electrode and at least one sustain electrode during the sustain period.

The seventh voltage is preferably higher than the fourth voltage and lower than a maximum voltage level of the sustain pulse.

A voltage difference between the fourth voltage and the seventh voltage is preferably equal to a voltage difference between the fifth voltage and the first voltage.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a graph of the relationship between the firing voltage and voltage difference among the electrodes of a prior art panel according to temperature.

FIG. 2 is a block diagram of a plasma display device according to an embodiment of the present invention.

FIG. 3 is a view of a unit frame for displaying a picture of the Plasma Display Panel (PDP) device according to an embodiment of the present invention.

FIG. 4 are views of driving waveforms supplied to each sub-field of the plasma display device according to an embodiment of the present invention.

FIG. 5 is a graph of the relationship between the firing voltage and voltage difference among the electrodes according to an embodiment of the present invention.

FIG. 6a and FIG. 6b are waveform diagrams for explaining the amount of light generated during reset discharging of the plasma display device according to both the prior art and embodiments of the present invention.

FIG. 7a and FIG. 7b are waveform diagrams for explaining the amount of light generated during address discharging of the plasma display device according to both the prior art and embodiments of the present invention.

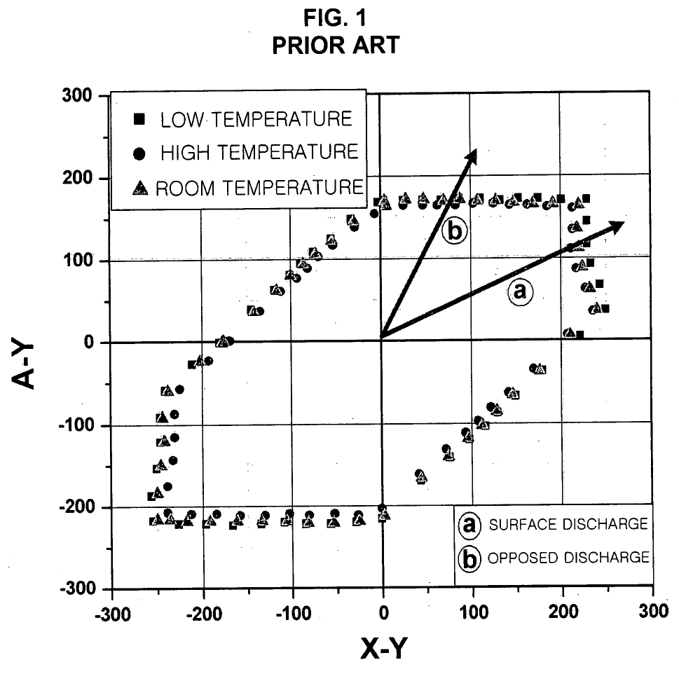

### DETAILED DESCRIPTION OF THE INVENTION

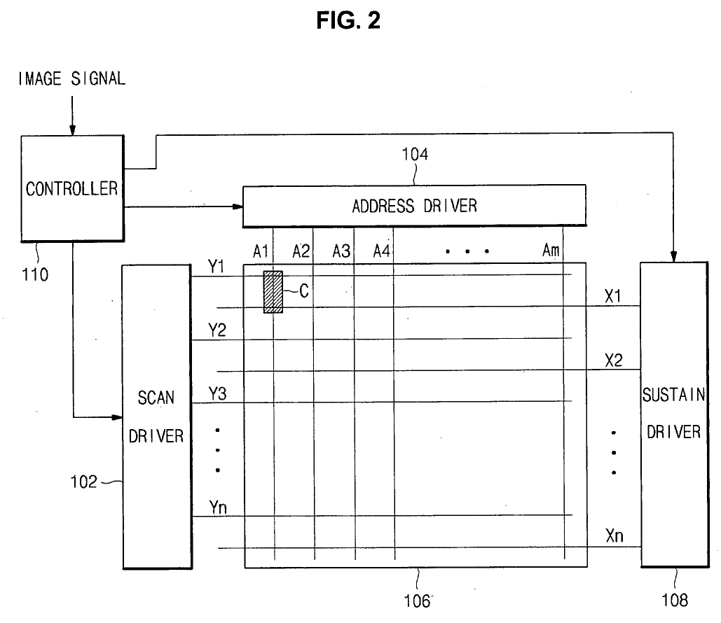

Hereinafter, exemplary embodiments of the present invention are explained in detail below with reference to FIG. 2 to FIG. 7.

FIG. 2 is a block diagram of a plasma display device according to an embodiment of the present invention.

Referring to FIG. 2, the plasma display device according to the present invention includes a PDP 106 that displays a picture, an address driver 104 for supplying data to address electrodes (A1 to Am) of the PDP 106, a scan driver 102 for driving scan electrodes (Y1 to Yn), a sustain driver 108 for driving sustain electrodes (X1 to Xn), and a controlleri 10 for controlling each of drivers 102, 104, and 108.

The PDP 106 displays a picture using a plurality of discharge cells C arranged in a matrix. The discharge cells C are defined by a plurality of address electrodes (A1 to Am) extending in a column direction, a plurality of scan electrodes (Y1 to Yn) extending in a row direction, and a plurality of sustain electrodes (X1 to Xn) extending in the row direction and configured in pairs with the scan electrodes (Y1 to Yn). The address electrodes (A1 to Am) cross the scan electrodes (Y1 to Yn) and sustain electrodes (X1 to Xn).

The controller 110 is driven with one frame divided into a plurality of sub-fields, each sub-field consists of a reset period, an address period, and a sustain period according to the time change on operation. Receiving the vertical/horizontal synchronizing signal, the controller 110 generates address control signals, scan control signals, and sustain control signals required for each driver 102, 104, and 108. The controller 110 controls each of drivers 102, 104, and 108 with the control signal supplied to the corresponding drivers 102, 104, and 108.

In response to the address control signal from the controller 110, the address driver 104 supplies data signals for selecting discharge cells to each address electrode A.

In response to the scan control signal from the controller 110, the scan driver 102 supplies the driving voltage to the scan electrodes (Y1 to Yn).

In response to the sustain control signal from the controller 110, the sustain driver 108 supplies the driving voltage to the sustain electrodes X.

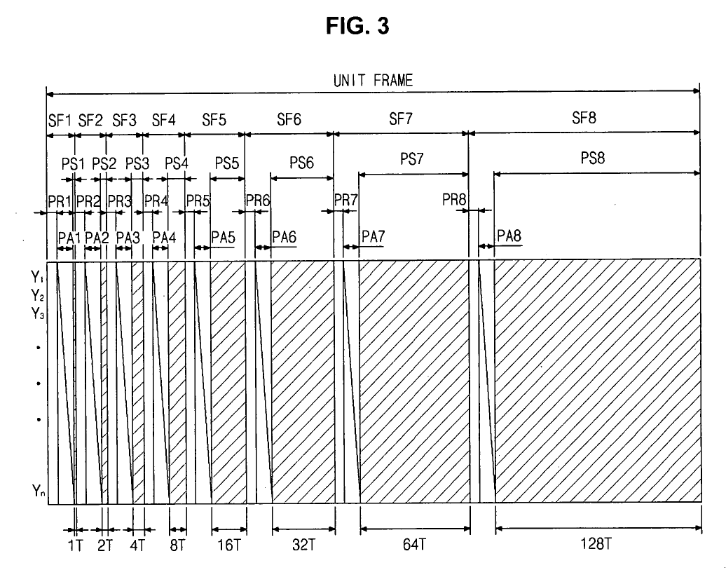

FIG. 3 is a view of a unit frame for displaying a picture of the PDP device according to an embodiment of the present invention.

As illustrated in FIG. 3, a unit frame for displaying a picture is classified into a plurality of sub-fields. A unit frame is shown to include eight sub-frames SF1˜SF8 and each sub-frame contains the reset period PR, the address period PA, the sustain period PS.

The reset period PR is a period for initializing all of the discharge cells, the address period PA is a period for addressing the discharge cells and dividing the discharge cell to be turned on and the discharge cell not to be turned off, and the sustain period PS is the period in which a predetermined number of sustain discharges are be performed in the selected (addressed) discharge cell during the address period PA. The designer can adjust the number of sustain discharges.

In the drawings, the unit frame is classified into eight sub-fields (SF1˜SF8) wherein the gray level weight value assigned to each sub-field from the first sub-field SF1 to the eighth sub-field SF8 is 1T, 2T, . . . 128T. However, the present invention is not limited to these values. The number of sub-fields in the unit frame can be more or less than 8, and the assignment of gray scale weight value by sub-field also is varied according to the design.

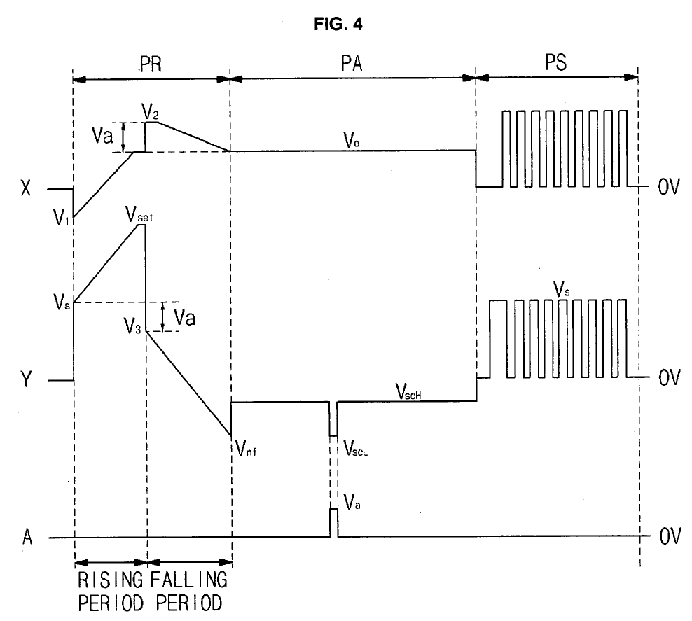

FIG. 4 are views of driving waveforms supplied during the reset period, the address period, and the sustain period of FIG. 3.

The first rising ramp pulse which rises gradually from a Vs voltage to a Vset voltage is supplied to the scan electrode Y during the rising period of the reset period PR of each sub-field, as illustrated in FIG. 4. At the same time, the second rising ramp pulse which rises gradually from a V1 voltage to a Ve voltage is supplied to the sustain electrode X. The voltage difference between the scan electrode Y and the sustain electrode X is almost constant with the passage of time, but the voltage difference between the scan electrode Y and the address electrode A increases with the passage of time. In this case, the voltage difference between the scan electrode Y and the sustain electrode X reaches the firing voltage and starts discharging during the former period and the latter period of the first and the second rising ramp pulses. On the contrary, while the voltage difference between the scan electrode Y and the address electrode A does not exceed the firing voltage during the former period of the first and second rising ramp pulses, the voltage difference reaches the firing voltage during the latter period of the first and second rising ramp pulses and starts discharging. Accordingly, a surface discharge between the scan electrode Y and the sustain electrode X during the rising period of the rest period PR becomes minimal, and the opposed discharge between the scan electrode Y and the address electrode A becomes maximal.

The first falling ramp pulse that decreases gradually from a V3 voltage to a Vnf voltage is supplied to the scan electrode during the falling period of the reset period PR. The V3 voltage is a voltage reduced by the Va voltage from the Vs voltage. At the same time, the second falling ramp pulse that decreases gradually from the V2 voltage to the Ve voltage is supplied to the sustain electrode X. The V2 voltage is the Va voltage added to the Ve voltage, and is lower than the voltage Vs. Then, the voltage difference between the scan electrode Y and the sustain electrode X increases in a narrow width with the passage of time. However, the voltage difference between the scan electrode Y and the address electrode A increases in a wide width with time. In this case, the surface discharge between the scan electrode Y and the sustain electrode X during the falling period of the rest period PR becomes minimal, and the opposed discharge between the scan electrode Y and the address electrode A becomes maximal. In wall charges formed on the scan electrode Y and the address electrode A of all of the discharge cells, wall charges unnecessary to the address discharge are erased and the discharge cells are initialized by this discharging.

For selecting discharge cells to emit light during the address period PA, a scan pulse having a VscL voltage is sequentially supplied to the scan electrodes Y, and a VscH voltage is biased to the scan electrode to which the VscL voltage is not supplied. The address pulse having the Va voltage is supplied to the address electrode A passing the discharge cell to be selected in a plurality of discharge cells formed by the scan electrode to which the voltage VscL is supplied, and the address electrode A which is not selected is biased to the reference voltage (0V in FIG. 4). The VscL voltage is equal or lower than the Vnf voltage.

The sustain pulse having a high level voltage (Vs in FIG. 4) and low level voltage (0V in FIG. 4) is alternatively supplied to the sustain electrode X and the scan electrode Y during the sustain period PS. A sustain discharge is generated between the scan electrode Y and the sustain electrode X of the discharge cell to be turned on.

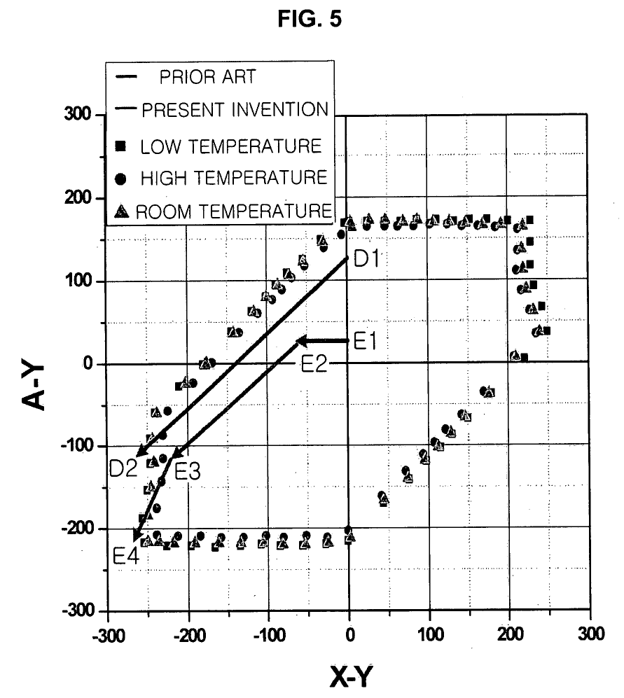

FIG. 5 is a graph of the relationship between the firing voltage and voltage difference among electrodes during the rising period of the reset period PR of FIG. 4. A-Y in FIG. 5 represents the voltage difference between the address electrode A and the scan electrode Y, and X-Y represents the voltage difference between the sustain electrode X and the scan electrode Y. Dots defining a hexagonal area represent the firing voltage. If the cell voltage of the voltage difference between electrodes exists in the inner hexagonal area, no discharge occurs, and if the cell voltage exists in the outer hexagonal area, a discharge is performed.

As illustrated in FIG. 5, once the rising ramp pulse is supplied to the scan electrodes in the prior art PDP, the cell voltage of the discharge cells moves from point D1 to point D2. A reset discharge is generated between the scan electrode and the sustain electrode in the discharge cells.

On the other hand, the voltage level of the sustain electrode X in the PDP according to an embodiment of the present invention falls from reference voltage (0V in FIG. 4) to V1 voltage. Accordingly, the cell voltage of the discharge cell moves from point E1 to point E2 since the value of X-Y is minus. Thereafter, the first rising ramp pulse, the second rising ramp pulse, and the reference voltage (0V in FIG. 4) are respectively supplied to the scan electrodes Y, the sustain electrodes X, and the address electrodes A. Accordingly, the cell voltage of the discharge cell moves to E4 point by way of E3 from E2 since A-Y has an increasing minus value, while the value of X-Y is almost constant in magnitude. That is, a firing voltage is not exceeding during the initial period of the first and second rising ramp pulse supplying, and when the firing voltage is exceeding during the latter period of the first and second rising ramp pulse supplying, the discharge is started. Accordingly, the surface discharge is started between the scan electrode Y and the sustain electrode X during the rising period of the rest period, and the opposed discharge is started between the scan electrode Y and the address electrode A during the rising period of the rest period.

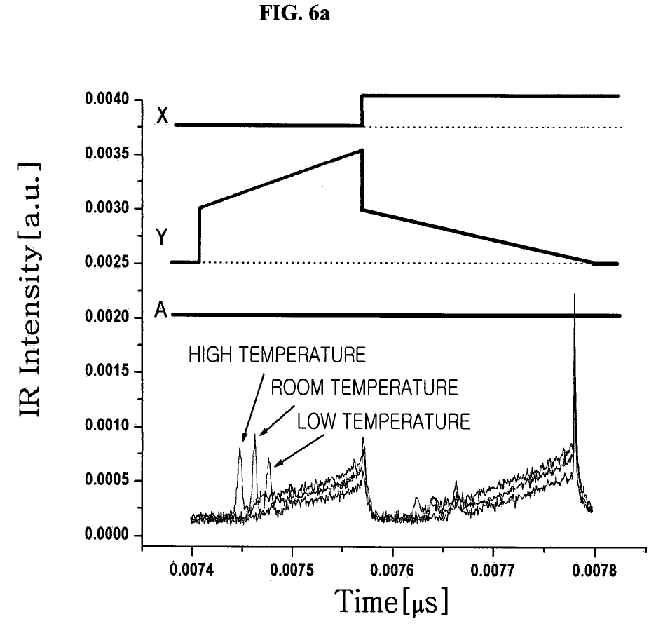

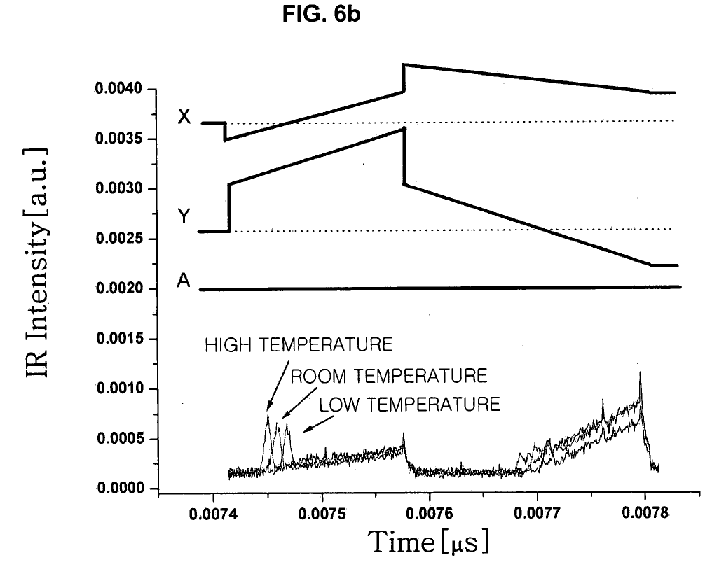

FIG. 6a and FIG. 6b are waveform diagrams for explaining the amount of light generated during reset discharging of the plasma display device according to both the prior art and embodiments of the present invention.

As illustrated in FIG. 6a, the discharge firing time of the reset discharge varies according to temperature of the prior PDP, and the amount of light generated due to the reset discharge also varies. More specifically, when the temperature of the panel increases, the reset discharge is generated quickly and the amount of light increases. When the temperature of the panel decreases, the reset discharge is generated slowly and the amount of light decreases.

On the contrary, the discharge firing time of the reset discharge in the PDP according to an embodiment of the present invention also varies according to temperature in a similar manner, and the amount of light generated due to the reset discharge also varies in a similar manner as depicted in FIG. 6b. That is, although the temperature of the panel varies, the difference in the reset discharge is minimized as compared with the prior art. Since the amount of light generated due to the reset discharge is almost constant whether the temperature of the panel increases or decreases, the dark image retention is decreased and the contrast ratio is improved.

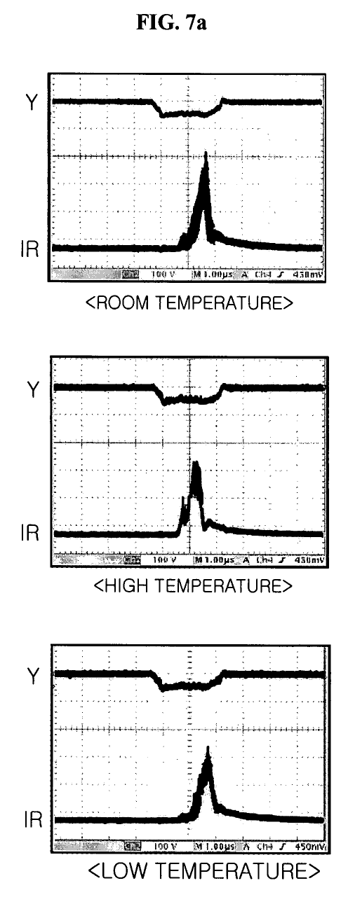

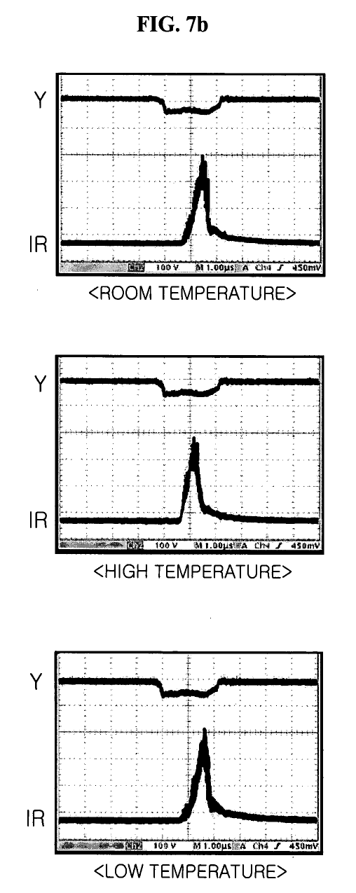

FIG. 7a and FIG. 7b are waveform diagrams for explaining the amount of light generated during address discharging of the plasma display device according to both the prior art and embodiments of the present invention.

As illustrated in FIG. 7a, the address discharge in the prior art PDP is weaker in strength at both high and low temperatures as compared to room temperature. Thus, the address discharge in the prior art PDP becomes unstable due to temperature variations. However, the address discharge of the PDP according to embodiments of the present invention is almost constant regardless of the temperature variations, as illustrated in FIG. 7b. Accordingly, the plasma display device according to embodiments of the present invention minimize the change of address discharge generated due to the variation of temperature so as to be driven stably.

While the present invention has been described in connection with what is considered to be exemplary embodiments, it is to be understood that the present invention is not limited to the disclosed embodiments, but rather is intended to cover various modifications and equivalent arrangements included within the spirit and scope of the appended claims.

As described above, the plasma display device and a driving method thereof according to the present invention reduces dark image retention as well as improving the contrast ratio, because the amount of light of the reset discharge is almost constant regardless of temperature variations. The plasma display device and a driving method thereof according to embodiments of the present invention minimize the change of address discharge generated due to temperature variations.

What is claimed:

1. A method of driving a plasma display device comprising:
dividing one frame into a plurality of sub-fields, each sub-field including a reset period, an address period, and a sustain period;
supplying a first rising ramp pulse to at least one scan electrode during a rising period of a reset period and simultaneously supplying a second rising ramp pulse to at least one sustain electrode; and
supplying a first falling ramp pulse to the at least one scan electrode during a falling period of the reset period and simultaneously supplying a second falling ramp pulse to the at least one sustain electrode.

2. The method of driving a plasma display device as claimed in claim 1, wherein the first rising ramp pulse rises gradually from a first voltage to a second voltage and the second rising ramp pulse rises gradually from a third voltage to a fourth voltage.

3. The method of driving a plasma display device as claimed in claim 2, wherein the first falling ramp pulse falls gradually from a fifth voltage to a sixth voltage and the second falling ramp pulse falls gradually from a seventh voltage to a fourth voltage.

4. The method of driving a plasma display device as claimed in claim 3, wherein a voltage level of the fifth voltage is lower than that of the first voltage.

5. The method of driving a plasma display device as claimed in claim 2, further comprising supplying a scan pulse to the at least one scan electrode in sequence during an address period and supplying an address pulse to at least one address electrode.

6. The method of driving a plasma display device as claimed in claim 5, further comprising supplying a bias voltage having a voltage level equal to the fourth voltage level to the at least one sustain electrode during the address period.

7. The method of driving a plasma display device as claimed in claim 4, further comprising alternately supplying the sustain pulse to the at least one scan electrode and at least one sustain electrode during the sustain period.

8. The method of driving a plasma display device as claimed in claim 7, wherein the seventh voltage is higher than the fourth voltage and lower than a maximum voltage level of the sustain pulse.

9. The method of driving a plasma display device as claimed in claim 8, wherein a voltage difference between the fourth voltage and the seventh voltage is equal to a voltage difference between the fifth voltage and the first voltage.

10. A plasma display device in which one frame is divided into a plurality of sub-fields and each sub-field includes a reset period, an address period, and a sustain period, the device comprising:
a Plasma Display Panel (PDP) including a plurality of scan and sustain electrodes, and including a plurality of address electrodes arranged to cross the scan and sustain electrodes;
a scan driver to supply a first rising ramp pulse to at least one scan electrode during a rising period of the reset period, and to supply a first falling ramp pulse to the at least one scan electrode during a falling period of the reset period;
a sustain driver to supply a second rising ramp pulse to the at least one sustain electrode during the rising period of the reset period, and to supply a second falling ramp pulse to the at least one sustain electrode during the falling period of the reset period.

11. The plasma display device as claimed in claim 10, wherein the first rising ramp pulse rises gradually from a first voltage to a second voltage and the second rising ramp pulse rises gradually from a third voltage to a fourth voltage.

12. The plasma display device as claimed in claim 11, wherein the first falling ramp pulse falls gradually from a fifth voltage to a sixth voltage and the second falling ramp pulse falls gradually from a seventh voltage to the fourth voltage.

13. The plasma display device as claimed in claim 12, wherein a voltage level of the fifth voltage is lower than that of the first voltage.

14. The plasma display device as claimed in claim 11, wherein the scan pulse is supplied to the at least one scan electrode in sequence during the address period and the address pulse is supplied to the at least one address electrode.

15. The plasma display device as claimed in claim 14, wherein a bias voltage having a voltage level equal to the fourth voltage level is supplied to the at least one sustain electrode during the address period.

16. The plasma display device as claimed in claim 12, wherein the sustain pulse is alternatively supplied to the at least one scan electrode and at least one sustain electrode during the sustain period.

17. The plasma display device as claimed in claim 16, wherein the seventh voltage is higher than the fourth voltage, and lower than a maximum voltage level of the sustain pulse.

18. The plasma display device as claimed in claim 17, wherein a voltage difference between the fourth voltage and the seventh voltage is equal to a voltage difference between the fifth voltage and the first voltage.
